(19) United States
(12) Patent Application Publication
(10) Pub. No.: US 2005/0074572 A1
(43) Pub. Date: Apr. 7, 2005

(54) Debris removal tape and method of using same

(75) Inventor: John L. Thiele, Newport, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/676,454

(22) Filed: Oct. 1, 2003

(51) Int. Cl. B32B 9/00

(52) U.S. Cl. 428/40.1; 428/343

(57) ABSTRACT

A tape and tape roll assembly for adhering thereto debris contained on a surface, such as a non-porous surface. The tape includes a high-adhesion, low-tack adhesive coating. The tape roll comprises a plurality of tape layers, with each tape layer removable from an adjacent underlying layer. The adhesive coating adheres to an outer surface of each layer. The adhesive coating adheres debris contained on the surface to be cleaned to an outermost tape layer of the tape roll without substantially adhering the outermost tape layer to the surface or unwinding the outermost tape layer from the tape roll. The adhesive coating includes at least about 56% by weight tackifier.

### BACKGROUND

The present invention generally relates to debris removal tape, typically in roll form, and more particularly to tape for removing debris from non-porous surfaces or non-fabric surfaces.

A variety of debris removal devices are known, especially lint removal devices. Lint removal devices remove lint and other small debris, such as hair, from clothing or other fabric surfaces. One known form of a lint removal device is lint removal tape, which may be used while still on a roll to remove lint and other small debris from the surface. In roll form, lint removal tape is typically wound on a core with the adhesive side of the tape wound outwardly for use. The lint removal tape roll is rolled against the surface to remove the lint and other small debris from the surface. The debris adheres to the adhesive side of the lint removal tape. When the outer wrap of the lint removal tape is saturated with debris, the outer wrap of the tape and its outer adhesive layer are removed from the roll and discarded. The underlying wrap of the tape and its outer adhesive layer are thereby exposed to be used for the removal of additional debris.

While conventional lint removal devices work well on clothing or other soft or porous surfaces, such rollers tend not to work as well on non-porous or non-fabric surfaces, such as flooring, counter tops, appliance surfaces and the like. When applied to such non-porous or non-fabric surfaces, the lint removal tape tends to adhere to the surface and unwind from the roll. This is disadvantageous in that the purpose of having the tape on a roll is to enable the user to roll a single layer of tape repeatedly over a soiled surface area until the layer of tape becomes saturated with debris. If the single layer of tape sticks to the surface and unwinds off the roll, it defeats the purpose of having the tape on a roll. Conversely, if the adhesion strength is lessened to prevent the debris removal tape from unwinding when it is rolled over the non-porous or non-fabric surface, the tape may not remove the lint or other small debris as well as desired.

### BRIEF SUMMARY

In one aspect, the present invention includes a tape for removing debris from a smooth or non-porous surface. The tape may be configured in a tape roll assembly comprising a plurality of tape layers, with each layer having a high-adhesion, low-tack adhesive coating on an outwardly facing surface. When the tape roll assembly is placed in contact with the surface, the adhesive coating adheres debris to an outermost tape layer of the tape roll without the outermost tape layer unwinding substantially from the roll. The debris removal tape includes a high-adhesion, low-tack adhesive with a tackifier content of at least about 56% by weight.

In another aspect, the present invention includes a method of removing contaminants from a surface to be cleaned, using a tape roll assembly such as that described above. The method involves rolling the tape roll along the surface to be cleaned such that the layer of adhesive adheres debris contained on the surface to be cleaned to an outermost tape layer of the tape roll.

### BRIEF DESCRIPTION OF THE DRAWINGS

FIG. 1 is a perspective view of one embodiment of a roll of debris removal tape of the present invention.

FIGS. 2A and 2B are top views of a portion of the debris removal tape.

FIG. 3 is an enlarged cross-sectional view of an alternative embodiment of the debris removal tape.

FIG. 4 is a perspective view of a roll of debris removal tape of the present invention mounted on an applicator.

FIG. 5 is a perspective view of a roll of debris removal tape of the present invention mounted on an alternative applicator.

### DETAILED DESCRIPTION

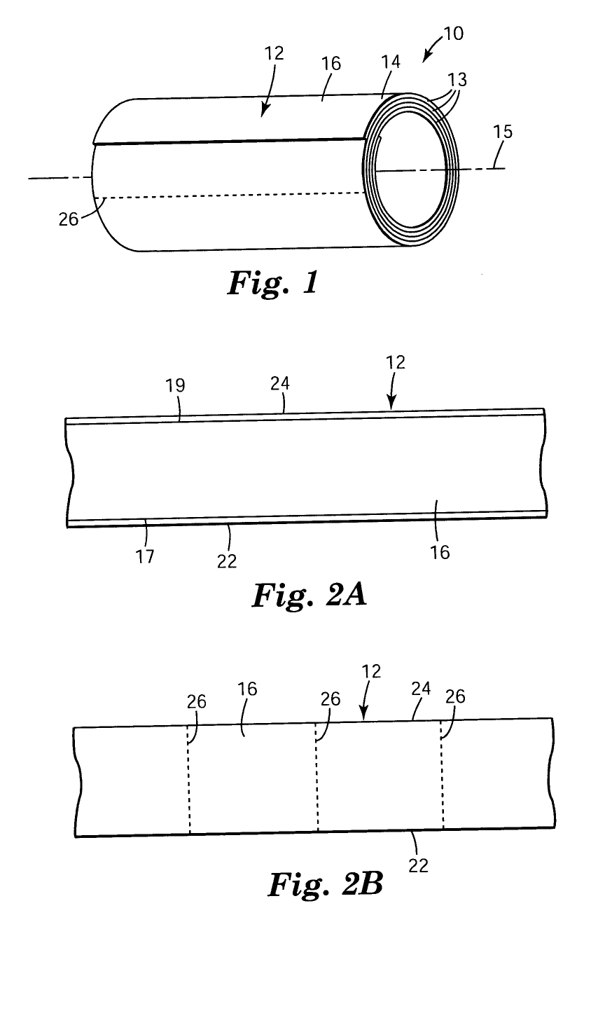

In one embodiment, the present invention includes a roll 10 of debris removal tape 12, as illustrated in FIG. 1. Debris to be removed may include small particulate matter, lint, dust, dirt, crumbs, hair, thread or other unwanted matter located on a surface to be cleaned. The roll 10 includes a plurality of wraps 13 of the debris removal tape 12 disposed about a center axis 15. The debris removal tape 12 has a backing 14 and a layer of adhesive 16 on a side 18 facing outwardly from the axis 15.

Examples of suitable backings 14 include paper, polymeric film materials including polyolefins such as polyethylene, polypropylene, copolymers of ethylene or propylene, halogenated polymers such as poly(vinyl chloride) and poly(vinylidene chloride), polyesters such as polyethylene terephthalate, polyurethanes, and poly(vinyl acetate) and vinyl acetate copolymers. Polypropylenes can include monoaxially oriented polypropylene, biaxially oriented polypropylene, simultaneously biaxially oriented polypropylene, and untensilized polypropylene, including untensilized isotactic polypropylene. Various types of non-woven synthetic polymeric backings, including spun-bond polyethylene, also could be used. The backing material may be compostable or degradable, may be colored, may be printed, and may be of different surface textures or embossed.

The backing 14 may also comprise a solid layer or mass of adhesive, of the same or different composition as that of the exposed outer adhesive layer 16. In such an embodiment, the adhesive would have a cohesive strength sufficient to enable it to be wound and unwound from the roll without the need for a backing layer formed of a non-adhesive material. A release coating or a release liner might be used to permit the solid layer or mass of adhesive to unwind from the roll without blocking.

The debris removal tape 12 includes at least one layer of pressure sensitive adhesive 16. The layer of adhesive 16 is a high-adhesion, low-tack pressure-sensitive adhesive. By high-adhesion it is meant that a suitable bond is formed between debris to be removed from the surface to be cleaned and the adhesive to adhere debris to the tape. By low-tack it is meant that the adhesive will not bond to the surface to be cleaned to an extent that it substantially prevents the removal of debris.

Examples of suitable adhesives for the layer of adhesive 16 include hot melt-coated formulations, transfer-coated formulations, solvent-coated formulations, and latex formulations. Pressure-sensitive adhesives can be based on, for example, natural rubber, styrene butadiene, butyl rubber, polyisobutylene, styrenic block copolymers, ethylene-vinyl acetate and related copolymers, poly-alpha olefins, acrylic adhesives, silicone, butadiene-acrylonitrile, polychloroprene, polybutadiene, atactic polypropylene, or repulpable materials, as described in Handbook of Pressure Sensitive Adhesive Technology, Third Edition, Edited by Donatas Satas, Satas & Associates, 1999. Other pressure-sensitive adhesives may be used for adhesive layer 16 of the adhesive article, such as those with the properties described in Adhesion and Adhesives Technology an Introduction, p. 216, Alphonsus V. Pocius, Hanser Gardner Publications, Inc., 1997.

Examples of adhesives useful in for the layer of adhesive 16 include those based on compositions of: polyacrylate, polyvinyl ether, diene-containing rubber such as natural rubber, polyisoprene, and polyisobutylene; polychloroprene; butyl rubber; butadiene-acrylonitrile polymer; thermoplastic elastomer; block copolymers such as styrene-isoprene and styrene-isoprene-styrene block copolymers, ethylene-propylene diene polymers, and styrene-butadiene polymer; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures of the above. Additionally, the adhesives can contain additives such as plasticizers, fillers, antioxidants, stabilizers, pigments, diffusing particles, curatives, and solvents.

Any suitable tackifier may be included in the adhesive layer 16. Suitable tackifiers include aliphatic, aliphatic/low aromatic, and polyterpene resins, as described in Handbook of Pressure Sensitive Adhesive Technology, Third Edition, Edited by Donatas Satas., Satas & Associates, 1999. Particularly suitable resins for SIS rubber include Escorez 1310 (Exxon Mobil Chemical, Houston Tex.) and Piccotac 95 (Eastman Chemical Co., Kingsport Tenn.).

The high-adhesion, low-tack adhesive has a tackifier content of at least about 56% by weight. In some embodiments, it may be desirable that the high-adhesion, low-tack adhesive has a tackifier content of about 58% by weight. It may in some embodiments be advantageous that the high-adhesion, low-tack adhesive has a tackifier content of about 60% by weight. Generally the higher the tackifier content of the adhesive layer, the higher the adhesion and lower the tack. It may be the case, however, that above tackifier contents in excess of 60% by weight, difficulties may be encountered in the processes of adhesive mixing and coating. If these potential difficulties are not encountered or are overcome, tackifier contents in excess of 60% by weight might be utilized depending on the desired material properties of the adhesive layer.

The adhesive preferably will not sufficiently adhere to the surface to be cleaned such that the tape 12 unwinds from the roll 10. Thus, it is desired that the adhesion force between the layer of adhesive 16 on the roll 10 and the surface to be cleaned is less than the force necessary to keep the tape on the roll. The adhesive tape described herein helps to reduce, if not eliminate, this problem by decreasing the initial tack and adhesion of adhesive layer 16 to the surface to be cleaned, while still retaining sufficient adhesion to adhere debris to the outer surface of the tape. Accordingly, it is preferable that the high-adhesion, low-tack adhesive layer exhibits a rolling ball tack, measured according to ASTM D3121, of at least approximately 500 mm, and more preferably that the adhesive layer exhibits a rolling ball tack of at least approximately 750 mm. Likewise, it is preferable that the high-adhesion, low-tack adhesive layer exhibits an adhesion to steel, as measured according to ASTM D3811-96, of at least approximately 5 N/10 mm.

In one aspect, the debris removal tape of the present invention is designed to pick up debris from non-porous surfaces, such as surfaces other than cloth or carpet. Such surfaces are generally smooth and include, but are not limited to, hardwood floors, tile floors, linoleum floors, countertops made of wood, plastic, ceramic or stone, metal surfaces, and walls or ceilings made of metal, wood or plaster. For example, the debris removal tape 12 is useful for cleaning smooth, stainless steel surfaces, such as those found in semiconductor clean room manufacturing areas, or in other manufacturing or industrial areas. As opposed to porous surfaces or fabric, for such non-porous surfaces, when the adhesive layer 16 of the roll 10 is rolled along the surface, a substantial portion of the surface to be cleaned typically is contacted by the adhesive. It is advantageous, therefore, to ensure that the tape does not adhere to the surface to an extent that the removal of debris is adversely affected.

In a preferred embodiment, the debris removal tape 12 may be formed into a coreless roll 10, having a plurality of wraps 13, with the adhesive layer 16 facing outwardly. As illustrated in FIG. 1, preferably the roll 10 of debris removal tape 12 need not include a core or any support material. However, roll 10 may optionally include a core, where the wraps 13 of debris removal tape 12 are wound about the core, as illustrated in FIGS. 4 and 5. Roll 10 may include an optional liner (not shown) interposed between the wraps 13 of tape 12.

As illustrated in FIG. 1, the debris removal tape 12 includes a layer of adhesive 16 coated across the entire width and length of the first side 18 of the debris removal tape 12. Alternatively, the tape 12 may include non-adhesive zones, 17 and 19 as illustrated in FIG. 2A. The non-adhesive zones 17 and 19 help the user separate the outermost wrap 13 of tape 12 from the roll 10. Non-adhesive zone 17 runs along a first edge 22 of the length of the debris removal tape 12. The other non-adhesive zone 19 runs along the length of second or opposite edge 24 of the debris removal tape 12. The tape 12 may include either non-adhesive zone 17 or 19 or both. The non-adhesive zones 17 and 19 may be first adhesively coated along with the rest of the tape, and then detackified by using waxes, lacquers, or inks, for example. Alternatively, the non-adhesive zones 17 and 19 may be left uncoated by adhesive. The non-adhesive zones may be present in any suitable location on the tape to assist the user in separating the outermost wrap of tape from the roll.

The debris removal tape 12, as illustrated in FIG. 2B, includes optional perforations 26 to facilitate removing the outer wrap of debris removal tape 12 from the roll 10 after that wrap of tape has been used and is to be discarded. The perforations 26 can be made before the debris removal tape 12 is rolled onto the roll 10, or after the roll 10 has been formed. Also, the perforations 26 on successive wraps can be located at the same or different circumferential locations on the roll 10. Alternatively, roll 10 may include perforations 26 that progressively increase each wrap in length relative to the length of adjacent wraps, such as is described in U.S. Pat. No. 5,763,038. Alternatively, after the tape 12 is formed into roll 10, a cut (not shown) can be formed through the roll to create discrete sheets and to facilitate removal of the outermost wrap of tape. For example, the cut could extend across the roll 10, except for the edges, or across the entire roll 10, except for the innermost wraps closest to the center axis 15 of the roll 10.

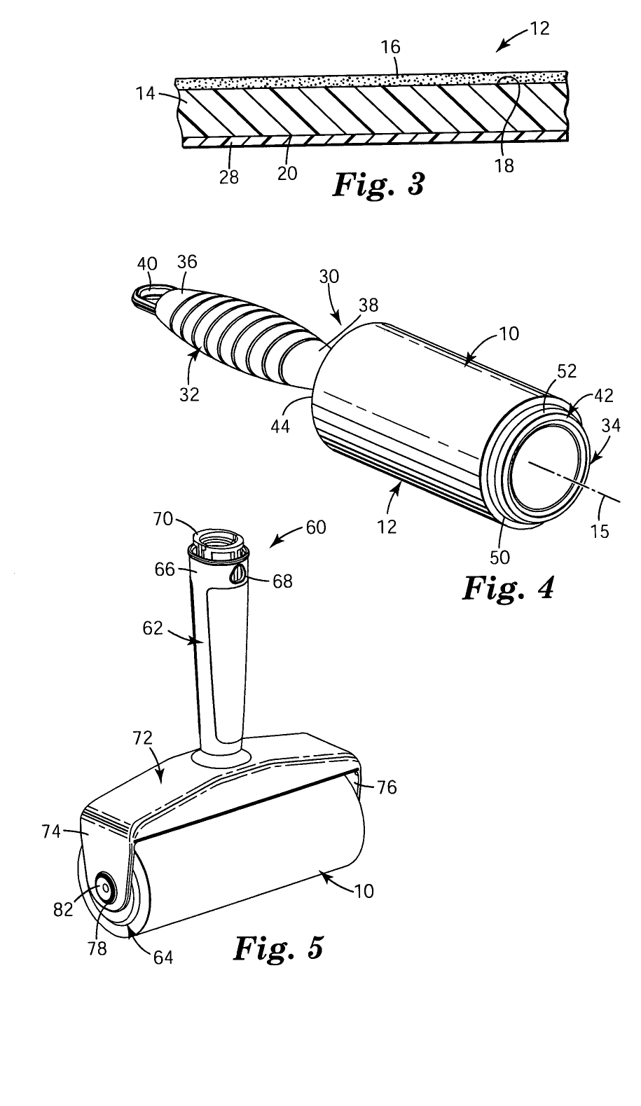

The debris removal tape 12, as illustrated in FIG. 3, optionally includes a release coating 28. The release coating 28 is formed on a second side 20 of the backing 14 to facilitate removing the outermost wrap of tape from the roll 10 after that wrap of tape has been used and is to be discarded. Other layers can be added to the tape, such as primers, to increase the adhesion of adhesive layer 16 to backing 14. Also, printed material can be located on the first side of the backing layer under the adhesive. This printed material can be advertising, instructions, or other information. Also, the tape could contain deodorants, perfumes, antistatic materials, and encapsulated cleaning chemicals. Also, the backing 14 can be modified such as by flame treatment, corona treatment, and roughening.

As illustrated in FIG. 4, the roll 10 may be mounted on an applicator 30. Any suitable applicator may be used with roll 10. The applicator 30 shown in FIG. 4 includes a handle portion 32 and a tape-receiving portion 34. The roll 10 of debris removal tape 12 can be slid onto the tape-receiving portion 34 of the applicator 30. The handle portion 32 may have any shape and can be contoured ergonomically to fit a hand. The handle portion 32 has a proximal end 36 and a connecting end 38. The free end 36 may have an opening 40 to permit hanging the applicator 30 on a hook for storage.

The tape-receiving portion 34 also includes a distal end 42 and a connecting end 44. The connecting end 38 of the handle portion 32 is connected to the connecting end 44 of the tape-receiving portion 34. The tape-receiving portion 34 includes a tape-receiving surface (not shown) that extends between the distal end 42 and the connecting end 44. Preferably, the tape-receiving surface is cylindrical and provides support to the tape roll 10. However, the tape-receiving surface may be formed of planar or curved sides that assist in holding the tape roll 10 in position.

To facilitate applying the roll 10 to the applicator 30, the distal end 42 has an outer lip 50 with a tapered portion 52. The taper portion 52 has a taper that decreases in diameter in a distal direction. In a preferred embodiment, the taper may be at an angle ranging from approximately 5° to approximately 15° in relation to the central axis 15. The taper permits the roll 10 to be applied over the distal end 42 without damaging the inner wraps of tape and ruining the roll 10.

If the roll 10 is coreless and is stretchable, it can be stretched over the slightly oversized and tapered outer lip 50, which can optionally be compressible and flexible. In one embodiment, the maximum diameter of the outer lip 50 is more than 5% larger than the diameter of the tape-receiving portion 34; the inner diameter of the tape roll 10 is bigger than the diameter of the tape-receiving portion 34 and smaller than the maximum diameter of the outer lip 50. Once the roll 10 is in place, the tape recovers to its original size.

An alternative embodiment of an applicator is generally indicated at 60 in FIG. 5. The applicator 60 includes a handle portion 62, a tape-receiving portion 64 and a yoke 72. The handle portion 62 is connected to and extends from a central portion of the yoke 72. The yoke 72 includes first and second spaced apart distal end portions 74 and 76 that rotatably engage ends 82 (only one being shown) of the tape-receiving portion 64. The roll 10 is disposed on the tape-receiving portion 64 such that the roll 10 is permitted to freely rotate as the roll 10 engages a surface (not shown).

The handle portion 62 may have any shape and can be contoured ergonomically to fit a hand. The handle portion 62 has a free end 66. The free end 66 of the handle portion 62 is preferably hollow and includes an opening 68 to permit hanging the applicator 60 on a hook for storage. The applicator 60 may optionally include an insert 70 for the free end 66 of the handle portion. This insert 70 may be used to mount the applicator 60 onto a longer handle (not shown).

To mount a new debris removal tape roll 10 on the applicator 60, the end portions 74, 76 are spread apart to disengage the tape-receiving portion 64 from the yoke 72. A new roll 10 is then slid onto the tape-receiving portion 64. The new tape 10 and tape-receiving portion 64 are inserted between the end portions 74, 76 of the yoke 72. The roll 10 and tape-receiving portion 64 may then rotate freely within the yoke 72.

The operation of the present invention will be further described with regard to the following example. This example is offered to illustrate further some various specific and preferred embodiments and techniques. It should be understood, however, that many variations and modifications might be made while remaining within the scope of the present invention.

### EXAMPLE

A resin premix was prepared by mixing 100 parts tackifier (Piccotac™ 95 available through Eastman Chemical Co., Kingsport, Tenn.) with four parts antioxidant (two parts Irganox™ 1076, available from Ciba Specialty Chemicals, Tarrytown, N.Y., and two parts Cyanox™ LTDP, available from Cytec Industries, Inc. West Patterson, N.J.). To the resin premix was added a rubber agent, specifically Kraton™ 1107 (available from Kraton Polymers, Houston, Tex.). The resin premix and the rubber agent were mixed to form the adhesive. The adhesive was hot-melt coated onto samples of lint-tape film having low adhesion backsizing. The samples were converted to thirty sheet lint tape refill rolls.

Floor surfaces of linoleum and carpet were used as the test surfaces. The tape roll samples then were tested for their tendency to adhere to a surface to be cleaned. The tape roll assembly was rolled against the surface using a forward-and-back motion for at least two passes, with one roll forward-and-back motion constituting a single pass. Each stroke could vary in length from a minimum of eighteen inches to a maximum of about thirty-six inches. Each pass was made relatively rapidly at about two or three seconds per pass. If the tape adhered to the surface and unwound from the roll assembly during any pass, a point was assigned. The test was repeated 5 times per roll, each time removing all contaminated tape from the outside of the roll between trials. The sum of the unwinds was reported with the test scale varying from a perfect zero (no unwind on any trial) to five (unwind on every trial).

No samples adhered to the carpeted surface, with each sample thus having an unwind tendency of zero on carpet. Test results for the linoleum flooring surface are shown in Table 1. At low tackifier content, typically below approximately 53% by weight, the tape samples tended to adhere to the linoleum and unwind from the roll. However, from the results listed in Table 1, it can be seen that as the tackifier content of the formulation increased, the tendency to unwind decreased.

TABLE 1
Adhesive Composition and Unwind Tendency

| | Kraton ™ | | | | | | |
|---|---|---|---|---|---|---|---|
| | 1107 | Resin | | | | | |
| Tape Roll | Rubber | Premix | Unwind | Kraton ™ | Piccotac ™ | Irganox ™ | Cyanox ™ |
| Identification | (parts) | (parts) | Tendency | 1107 | 95 | 1076 | LTDP |
| 1 | 100 | 104 | 4 | 49.0% | 49.0% | 1.0% | 1.0% |
| 2 | 100 | 104 | 4 | 49.0% | 49.0% | 1.0% | 1.0% |
| 3 | 100 | 124 | 2 | 44.6% | 53.2% | 1.1% | 1.1% |
| 4 | 100 | 124 | 1 | 44.6% | 53.2% | 1.1% | 1.1% |
| 5 | 100 | 134 | 3 | 42.7% | 55.1% | 1.1% | 1.1% |
| 6 | 100 | 134 | 1 | 42.7% | 55.1% | 1.1% | 1.1% |
| 7 | 100 | 144 | 1 | 41.0% | 56.7% | 1.1% | 1.1% |
| 8 | 100 | 144 | 0 | 41.0% | 56.7% | 1.1% | 1.1% |
| 9 | 100 | 154 | 0 | 39.4% | 58.3% | 1.2% | 1.2% |
| 10 | 100 | 154 | 0 | 39.4% | 58.3% | 1.2% | 1.2% |
| 11 | 100 | 174 | 0 | 36.5% | 61.1% | 1.2% | 1.2% |
| 12 | 100 | 174 | 1 | 36.5% | 61.1% | 1.2% | 1.2% |

Unwind Tendency: 5 trials on test surface with fresh sheet.
1 point for each unwind (scale 0 = no unwind, 5 = all trials unwound)

Tape properties for tape roll samples shown in Table 1 are listed in Table 2. Adhesion to stainless steel was measured according to Test Method A of ASTM D3330/D 3330M-96, at a peel rate of 30.5 centimeters per minute. The tape roll samples were applied to a stainless steel panel, and peeled from the panel in the 180 degree peel test. Unwind force was measured according to ASTM D 3811-96. A chuck was made for mounting the coreless debris removal tape roll onto the lower clamp of an Instron 5565 tensile tester. The unwind test was carried out on samples of 10.16 cm width at an unwind rate of 30.5 centimeters per minute. Rolling ball tack of the adhesive layer side of the tape was measured according to ASTM D3121 with the modification that extra lengths of tape were used to accommodate for increased rolling distances.

TABLE 2
Tape Properties

| | | | | Coating |
|---|---|---|---|---|
| Tape Roll | Adh. To Steel | Rolling Ball | Roll Unwind | Weight |
| Identification | (N/10 cm) | (mm) | (N/10 cm) | (g/m²) |
| 1 | 4.91 | 316.7 | 1.14 | 17.16 |
| 2 | 6.32 | 269.7 | 2.10 | 24.27 |
| 3 | 5.47 | 600+ | 0.83 | 15.07 |
| 4 | 6.87 | 507.7 | 1.83 | 23.85 |
| 5 | 5.20 | 600+ | 0.84 | 15.90 |
| 6 | 7.24 | 516.7 | 1.61 | 24.69 |
| 7 | 5.88 | 750+ | 0.68 | 16.32 |
| 8 | 7.42 | 635-890+ | 1.30 | 24.27 |
| 9 | 5.11 | 750+ | 0.50 | 19.90 |
| 10 | 7.36 | 890+ | 1.22 | 23.44 |
| 11 | 6.02 | 1140+ | 0.43 | 15.90 |
| 12 | 8.40 | 1500+ | 0.70 | 23.44 |

From the data listed in Table 2, it can be seen that at a constant coating weight, adhesion generally increased and tack generally decreased as the tackifier content of the adhesive was increased. Surprisingly, the tendency to unwind is relatively independent of adhesive coating weight within the ranges tested.

The tests and test results described above are intended solely to be illustrative, rather than predictive, and variations in the testing procedure can be expected to yield different results.

The present invention has now been described with reference to several specific embodiments foreseen by the inventor for which enabling descriptions were available. Insubstantial modifications of the invention, not presently foreseen, may nonetheless constitute equivalents thereto. Thus, the scope of the present invention should not be limited by the details and structures described herein, but rather solely by the following claims, and equivalents thereto.

1. A tape for removing debris from a surface to be cleaned, comprising:
a backing; and
a pressure sensitive adhesive layer that includes at least about 56% by weight tackifier;
wherein the tape is adapted to remove debris from a surface without substantially adhering to the surface.

2. The tape of claim 1, wherein the adhesive layer includes at least about 58% by weight tackifier.

3. The tape of claim 1, wherein the adhesive layer includes at least about 60% by weight tackifier.

4. The tape of claim 1, wherein the adhesive layer includes more than 60% by weight tackifier.

5. The tape of claim 1, wherein the adhesive layer exhibits a rolling ball tack distance according to ASTM D3121 of at least about 500 mm.

6. The tape of claim 1, wherein the adhesive layer exhibits a rolling ball tack distance according to ASTM D3121 of at least about 750 mm.

7. The tape of claim 1, wherein the adhesive layer exhibits a rolling ball tack distance according to ASTM D3121 of at least about 1000 mm.

8. The tape of claim 1, wherein the adhesive layer exhibits an adhesion to stainless steel in accordance with ASTM D3330/D3330M of at least about 5 N/10 mm.

9. The tape of claim 1, wherein the surface to be cleaned includes a non-porous surface.

10. A tape roll, comprising:
a plurality of tape layers, each tape layer removable from an adjacent underlying layer; and
an adhesive coating adhered to an outer surface of each layer, the adhesive coating including at least about 56% by weight tackifier.

11. The tape roll of claim 10, wherein the adhesive coating includes at least about 58% by weight tackifier.

12. The tape roll of claim 10, wherein the adhesive coating includes at least about 60% by weight tackifier.

13. The tape roll of claim 10, wherein the adhesive coating includes more than 60% by weight tackifier.

14. The tape roll of claim 10, wherein the adhesive coating exhibits a rolling ball tack distance according to ASTM D3121 of at least about 500 mm.

15. The tape roll of claim 10, wherein the adhesive coating exhibits a rolling ball tack distance according to ASTM D3121 of at least about 750 mm.

16. The tape roll of claim 10, wherein the adhesive coating exhibits a rolling ball tack distance according to ASTM D3121 of at least about 1000 mm.

17. The tape roll of claim 10, wherein the adhesive coating exhibits an adhesion to stainless steel in accordance with ASTM D3330/D3330M of at least about 5 N/10 mm.

18. A tape roll for removing debris from a surface to be cleaned, comprising:
a plurality of tape layers, each tape layer removable from an adjacent underlying layer; and
an adhesive coating that includes at least about 56% by weight tackifier, adhered to an outer surface of each layer;
wherein the adhesive coating of the outermost tape layer removes debris from the surface to be cleaned without substantially unwinding from the adjacent underlying layer.

19. The tape roll of claim 18, wherein the surface to be cleaned includes a non-porous surface.

20. The tape roll of claim 18, wherein the adhesive coating includes at least about 58% by weight tackifier.

21. The tape roll of claim 18, wherein the adhesive coating includes at least about 60% by weight tackifier.

22. The tape roll of claim 18, wherein the adhesive coating includes more than 60% by weight tackifier.

23. The tape roll of claim 18, wherein the adhesive coating exhibits a rolling ball tack distance according to ASTM D3121 of at least about 500 mm.

24. The tape roll of claim 18, wherein the adhesive coating exhibits a rolling ball tack distance according to ASTM D3121 of at least about 750 mm.

25. The tape roll of claim 18, wherein the adhesive coating exhibits a rolling ball tack distance according to ASTM D3121 of at least about 1000 mm.

26. The tape roll of claim 18, wherein the adhesive coating exhibits an adhesion to stainless steel in accordance with ASTM D3330/D3330M of at least about 5 N/10 mm.

27. A tape roll for removing debris from a surface to be cleaned, the tape roll comprising:
a plurality of tape layers, each tape layer removable from an adjacent underlying layer; and
an adhesive coating adhered to an outer surface of each layer that includes at least about 56% by weight tackifier, wherein the adhesive coating adheres debris contained on the surface to be cleaned to an outermost tape layer without substantially adhering the outermost tape layer to the surface to be cleaned.

28. The tape roll of claim 27, wherein the surface to be cleaned includes a non-porous surface.

29. The tape roll of claim 27, wherein the adhesive coating includes at least about 58% by weight tackifier.

30. The tape roll of claim 27, wherein the adhesive coating includes at least about 60% by weight tackifier.

31. The tape roll of claim 27, wherein the adhesive coating includes more than 60% by weight tackifier.

32. The tape roll of claim 27, wherein the adhesive coating exhibits a rolling ball tack distance according to ASTM D3121 of at least about 500 mm.

33. The tape roll of claim 27, wherein the adhesive coating exhibits a rolling ball tack distance according to ASTM D3121 of at least about 750 mm.

34. The tape roll of claim 27, wherein the adhesive coating exhibits a rolling ball tack distance according to ASTM D3121 of at least about 1000 mm.

35. The tape roll of claim 27, wherein the adhesive coating exhibits an adhesion to stainless steel in accordance with ASTM D3330/D3330M of at least about 5 N/10 mm.

36. A method of removing contaminants from a surface to be cleaned, the method comprising the steps of:
providing a tape roll comprising:
a plurality of tape layers, each tape layer removable from an adjacent underlying layer; and
an adhesive coating adhered to an outer surface of each layer, wherein the adhesive coating includes at least about 56% by weight tackifier; and
rolling the tape roll along the surface to be cleaned such that the adhesive coating adheres debris contained on the surface to be cleaned to an outermost tape layer of the tape roll.

37. The method of claim 36, wherein the adhesive coating on the outermost tape layer adheres more strongly to the underlying layer than to the surface to be cleaned.

38. The method of claim 36, wherein the adhesive coating includes at least about 58% by weight tackifier.

39. The method of claim 36, wherein the adhesive coating includes at least about 60% by weight tackifier.

40. The method of claim 36, wherein the adhesive coating includes more than 60% by weight tackifier.

41. The method of claim 36, wherein the adhesive coating exhibits a rolling ball tack distance according to ASTM D3121 of at least about 500 mm.

42. The method of claim 36, wherein the adhesive coating exhibits a rolling ball tack distance according to ASTM D3121 of at least about 750 mm.

43. The method of claim 36, wherein the adhesive coating exhibits a rolling ball tack distance according to ASTM D3121 of about at least 1000 mm.

44. The method of claim 36, wherein the adhesive coating exhibits an adhesion to stainless steel in accordance with ASTM D3330/D3330M of at least about 5 N/10 mm.
